(19) United States
(12) Patent Application Publication
(10) Pub. No.: US 2024/0341502 A1
(43) Pub. Date: Oct. 17, 2024

(54) DISPLAY OF CONSUMER GOODS AND ASSOCIATED PACKAGING

(71) Applicant: Kimberly-Clark Worldwide, Inc., Neenah, WI (US)

(72) Inventor: Joseph E. Pierce, Appleton, WI (US)

(21) Appl. No.: 18/580,281

(22) PCT Filed: Jul. 23, 2021
(86) PCT No.: PCT/US21/42871

§ 371 Date: Jan. 18, 2024

(51) Int. Cl. A47F 3/02; A47F 7/00; A47K 10/32; B65D 83/08

(52) U.S. Cl. CPC A47F 3/02; A47F 7/0007; A47K 10/32; B65D 83/0805

(57) ABSTRACT

An array of consumer products, particularly tissue products, and more particularly an array of bundled tissue products and an array of unfilled packages for the bundled consumer products. The consumer products may include a stack of tissue sheets at least partially overwrapped with a wrapper, which preferably includes brand name. The unfilled packages are preferably provided in an un-erected state and may be erected by a consumer to receive, store, and dispense the bundled consumer product. Preferably the unfilled packages also include the same brand name included on the bundled consumer product. The array is preferably displayed on a store shelf and provides the consumer with the ability to mix and match their desired consumer product with their desired packaging.

### BACKGROUND

Consumer products, particularly tissue products, and especially facial tissue products, have in the past been marketed and sold as a combination of both the product to be used by the consumer, such as a sheet of facial tissue, and its packaging, which has been specifically designed to store and dispense the product. Often the package housing the products serves multiple purposes. For example, the packaging may describe the product located within the packaging, communicate the manufacturer of the product, and provide a convenient method for dispensing the product. The packaging may provide navigational cues to assist consumers in finding their products quickly and easily.

In certain instances, the packaging may also provide a decorative function to consumers. This is particularly desirable with tissue cartons, which are often displayed within the home. To satisfy consumer needs for decorative tissue cartons manufacturers quite commonly apply decorative printing to those panels of the tissue carton which are intended to remain after the carton has been opened. In certain instances, the decorative panels may be further enhanced by providing brand identification and product information on removable panels or overwraps meant to be discarded upon opening.

The consumer desire for aesthetically appealing carton graphics is often in tension with their desire for a particular product. In other words, aesthetics must be weighed against the need for a particular product having particular physical attributes. Often the consumer will choose aesthetics over a particular product, leaving the consumer dissatisfied during use occasions. This dissatisfaction may lead the consumer to have a negative view of the product and the associated brand and negatively affect their repurchase decision.

Accordingly, there is a need for an display of consumer products, particularly tissue products, and more particularly a display of bundled facial tissue products and associated packaging that can be purchased by the consumer separately and satisfy the consumer's desire for both aesthetic packaging and a product having all the needed physical properties.

### SUMMARY

The present invention provides a display of consumer products, particularly tissue products, and more particularly an array of packaged tissue products, such as bundles of tissue products, and an array of unfilled packages for the consumer products. In certain preferred embodiments the consumer goods are tissue products, more particularly a stack of tissue sheets. The consumer goods are preferably packaged, such as bundles of tissue products at least partially overwrapped with a wrapper. The unfilled packages are preferably provided in an un-erected state and may be erected by a consumer to receive, store, and dispense the bundled consumer product. Preferably the unfilled packages and packaged consumer products include a common brand name that communicates to the consumer the products are related and are to be used together. The array of packaged products and packaging are preferably displayed on a store shelf and provides the consumer with the ability to mix and match their desired consumer product with their desired packaging.

Accordingly, in one embodiment, the present invention provides a display of consumer products comprising an array of two or more packaged consumer goods, the two or more packaged consumer goods having at least one physical property that is different; and an array of two or more packages for the packaged consumer goods, the two or more packages having at least one physical property that is different and wherein the packages are unfilled.

In other embodiments the present invention provides a display of tissue products and packaging comprising: an array of two or more bundles of folded tissue products, the two or more tissue products having at least one physical property that is different; and an array of two or more packages for receiving, storing and dispensing the two or more tissue products, the two or more packages having at least one physical property that is different and wherein the packages are unfilled.

In still other embodiments the present invention provides a display of tissue product and packaging for storing and dispensing the tissue product comprising: an array of two or more tissue products, the two or more tissue products having at least one physical property that is different; and an array of two or more packages configured to receive, store, and dispense a tissue product, the two or more packages having at least one physical property that is different and wherein the packages are unfilled.

In yet other embodiments the present invention provides a display of tissue product and packaging for storing and dispensing the tissue product comprising: an array of two or more tissue products, the two or more tissue products having at least one physical property that is different; an array of two or more packages configured to receive, store and dispense a tissue product, the two or more packages having at least one physical property that is different and wherein the packages are unfilled and displayed in an un-erected state; an array of two or more packages configured to receive, store, and dispense a tissue product, the two or more packages having at least one physical property that is different and wherein the packages are unfilled and displayed in an erected state; and an array of two or more packaged tissue products comprising a package comprising a plurality of panels and a dispensing opening disposed on at least one of the panels and a plurality of tissue products disposed within the package.

### DEFINITIONS

As used herein the term “Product” generally refers to any object, material, or substance that is intended for use by a consumer. In certain nonlimiting embodiments, a product may be a packaged consumer product such as tissue products, feminine care products, household care products, personal care products, and combinations thereof.

As used herein the term “Tissue Product” generally refers to various paper products, such as facial tissue, bath tissue, paper towels, napkins, and the like. Normally, the basis weight of a tissue product useful in the present invention is greater than about 20 grams per square meter (gsm), such as from about 20 to about 60 gsm and more preferably from about 30 to about 50 gsm

As used herein the terms “Container” and “Package” generally refers to a receptable for receiving and storing a product, particularly a tissue product and more particularly a stack of folded tissue products. In certain preferred embodiments containers are not only capable of receiving and storing a product, they are also specifically designed to dispense the product stored therein. One non-limiting example of a container useful in the present invention is a conventional cubic tissue carton having a plurality of interconnected panels and an internal volume for receiving and storing a folded stack of tissue sheets, the carton having a dispensing opening on one of its panels for dispensing the tissue sheets.

As used herein, when referring to a container, the term “un-erected” refers to the state of container prior to being formed into a three dimensional shape with an internal volume to receive and store a product. For example, an un-erected container may comprise a paperboard container blank with an unformed product space, wherein the walls forming the blank are joined together and lie flat against one another. Thus, in certain embodiments, an un-erected container may be provided in a substantially flat configuration.

As used herein, when referring to a container, the term “Unfilled” refers to a container that does not contain a product. For example, an unfilled container may be an erected container having an internal volume that does not contain a product.

As used herein the term “Array” generally refers to the arrangement of commonly associated products or packages in a display. Preferably all of the products within an array are visible to a consumer during the consumer's purchasing decision process. In certain instances, the products or packages within a given an array of common interest to a consumer but differ from one another in at least one aspect. For example, in one embodiment, an array of products may comprise two or more tissue products where the tissue products differ in respect to one another in regard to tensile strength. In other instances, an array of packages may comprise two or more packages designed to receive, store, and dispense tissue products where the packages having different graphics. In a particularly preferred embodiment, all of the products in a given array possess a common brand name.

As used herein the term “Brand Name” means a source identifier. An example of a brand name is Kleenex®, which is also a trademark. In certain preferred embodiments all the products in an array have the same brand name. The brand name may be displayed on the product, the product packaging, the shelf, a shelf talker, a visual display, a hanging banner, or the like. In addition to a brand name the product may also include a product descriptor that describes one or more product attributes of the product.

As used herein the term “Indica” generally refers to a marking intended to communicate with a consumer. Indicia may be either textual, such as, for example, a brand name, a product descriptor, or non-textual, such as, for example, such as a graphic element or an icon.

As used herein the term “Non-textual Indicia” generally refers to a property of the consumer good that is communicated to a consumer through the consumer's senses. In one example, non-textual indicia may communicate, even intuitively communicate, to a consumer through sight (visual indicia), through touch (textural indicia), sound (audio indicia) and/or through smell (scent indicia).

As used herein the term “Physical Property” generally refers to a property of a product, such as a tissue product, that is measurable. Physical properties of tissue products useful in the present invention may include, for example, surface topography, the number of plies, absorbency, caliper, basis weight, bulk, softness, slough, and tensile properties such as strength, modulus, and energy absorption. Physical properties may also include any lotions or therapeutic agents added to a tissue product during manufacture. In other instances, the physical properties of packages useful in the present invention may include, materials, panel arrangement and configuration, erected size, shape and volume, dispensing configuration, color, texture, and package graphics.

As used herein the term “Common Physical Property” means a physical property that is present in two or more consumer products wherein the value of the first product property is not more or less than ten percent of the same property in the second product. For example, where a first product is a tissue product having a geometric mean tensile strength (GMT) of about 600 g/3″ and a second product is a tissue product having a GMT of about 650 g/3″, the first and second products share a common physical property, where the property is GMT.

A physical property may be different between products where the difference in the common physical property is more or less than ten percent. For example, where a first product is a tissue product having a geometric mean tensile strength (GMT) of about 600 g/3″ and a second product is a tissue product having a GMT of about 700 g/3″, the two products differ with respect to GMT.

### DETAILED DESCRIPTION

Generally, the present invention provides for a display of products, particularly consumer products, and packaging for the same. The products and product packaging may be displayed on a shelf at a point of sale where they may be viewed, selected, and purchased by the consumer. In certain instances, the display may comprise both an array of products and an array of packages for the products. In this manner, the consumer may choose the product and product packaging separately. In a particularly preferred embodiment, the consumer not only chooses the product and product packaging separately but erects the product package themselves and fills the package with the product they have chosen. Further, in certain instances, the product package may be refillable such that the consumer may refill the package with the same product they originally selected or may choose a different product from the product array to fill the package.

Accordingly, in certain preferred embodiments, the invention provides an array of tissue products and containers, also referred to herein as packages, for storing and dispensing the tissue products, where the containers are provided in an unfilled state. The tissue products may be either wet or dry, or a combination thereof. The physical properties of the tissue products that make up the array may differ from one another in at least one material manner. For example, a first tissue product may have a first ply count, a first product basis weight and may be untreated, while a second tissue product in the array may have a second ply count, that is different than the first, a second basis weight, that is different than the first, and may be treated with a surface treatment, such as a lotion. As used herein, products may differ from one another when a given product physical property, such as the number of plies, basis weight, sheet bulk, tensile strength (measured as geometric mean tensile strength) differs between the two products by at least 10% or greater, more preferably at least 20% or greater, and still more preferably at least 30% or greater.

In addition to tissue products, particularly two or more tissue products having at least one physical property that differs, the display comprises any array of containers for the tissue products. In particular embodiments the containers may be specifically designed to receive, store, and dispense the tissue products on display with the containers. The containers may be constructed from different materials, or have different shapes, dispensing configurations, volumes, surface areas, capacity, graphics, and the like. In this manner the containers may have different functionality or different aesthetic appearances that provide the consumer with variety of choices when shopping the display.

In certain instances, in addition to being unfilled, the containers are provided in an un-erected state and are erected by the consumer after purchase. The un-erected containers may be displayed in a substantially flat configuration, which the consumer erects by folding into an erect configuration. Once erected the consumer may fill the container with a tissue product selected from the tissue product array. While the containers may be displayed in an un-erected, substantially flat, configuration, the invention is not so limited, and it may simply be that the containers are displayed in a first configuration and are transformed by the consumer after purchase into a second configuration.

Generally, the array of tissue products and tissue product packaging may be displayed on a shelf at a point of sale, such as within a retail store. In this manner the products and packaging within the display are visible to a consumer during the consumer's purchasing decision process. The display may also include erected, unfilled, containers and/or erected and filled containers. Preferably the display also includes indicia, which may be textual or non-textual, to aid the consumer in shopping the display. Further, the display may include a source identifier, such as a trademark or brand name, that is common to all of the products and containers within the display.

The display comprise an array of consumer products, particularly packaged consumer products. The consumer products may be packaged in a manner that requires them to be repackaged by the consumer for use. For example, in one particularly preferred embodiment, the array comprises overwrapped stacks of tissue sheets. The overwrap is not provided with a means of dispensing the sheets, which requires the consumer to remove the overwrap and repackage the tissue sheets in a package with a dispenser for use. While in certain embodiments it may be preferred that the consumer goods be tissue sheets and the packaging be an overwrap, the invention is not so limited and the consumer good may be any one of a number of consumer goods and the packaging may be any one of a number of well-known packaging forms.

In certain preferred embodiments the array of packaged consumer goods comprising a brand name and optionally indicia disposed on the package overwrap. The brand name may act as a source identifier and be common to all of the packages within the display and the indicia may be indicative of one or more physical properties of the packaged good. In a particularly preferred embodiment, the packaged goods are tissue products which have been overwrapped with a wrapper having a brand name and indicia. For example, the tissue products may comprise folded sheets of tissue that have been stacked and overwrapped with a film and provided with brand name and indicia.

In certain embodiments a plurality of products, such as individual sheets of tissue product, are packaged together, such as overwrapping by a wrapper, such as a plastic film or paper overwrap, to form a bundle of packaged goods. In a particularly preferred embodiment a plurality of individual tissue products, such as a plurality of tissue sheets or rolls of tissue, are packaged together by overwrapping with a film overwrap. In yet other embodiments the products comprise a disposable absorbent article, such as disposable diapers, training pants, incontinence pads and pants, sanitary napkins, tampons, pantiliners, wipes, wet wipes, bandages, and pessaries disposed in carton, container, bag, or overwrap.

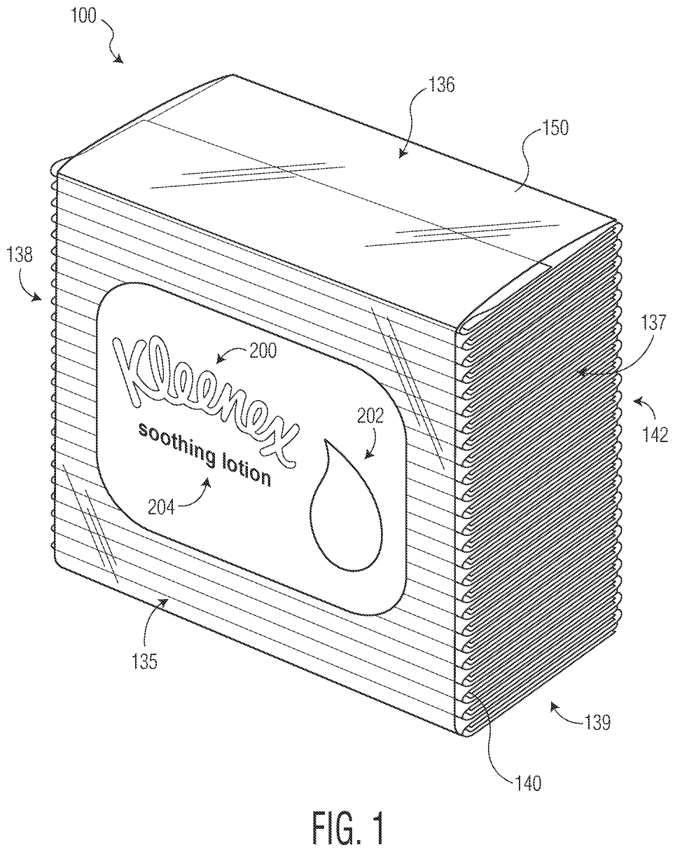

Referring to FIG. 1 there is illustrated a product bundle 100. The product bundle generally comprises a collection of packaged products, such as those disclosed above. The product bundle 100 is illustrated as a single outline having a cube shape having a front 135, top 136, opposing sides 137, 138 and bottom 139 and back (not illustrated). Although the illustrated bundle 100 is cubic, one skilled in the art will appreciate that other shapes are contemplated. Generally, the shape of the bundle is dictated by the shape of the product items being bundled.

The illustrated bundle 100 comprises a plurality of individually folded sheets of tissue 140 that are stacked on top of each other to form a stack 142. The stack 142 is at least partially surrounded by a packaging film 150 (also referred to herein simply as an overwrap or a wrapper). The packaging film 150 extends around the bundle 100 contacting the top 136 and bottom 139 surfaces and covering a portion of the front surface 135 as well as the back surface (not shown). Preferably the film covers at least two surfaces of the packaged goods such that the goods are retained in the bundle in a stable manner.

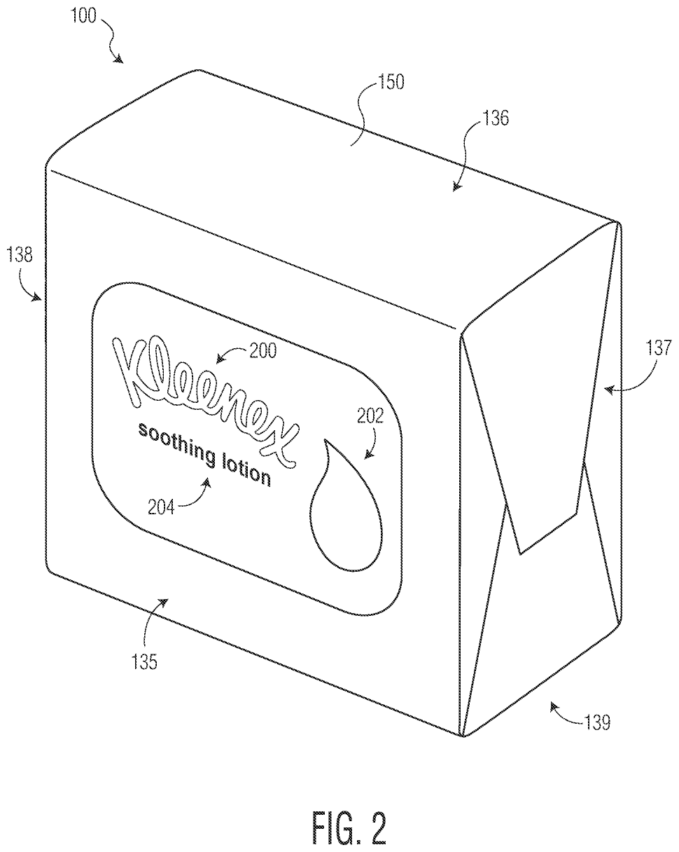

Although the packaging film 150 is illustrated in FIG. 1 as a band which only covers the top, bottom, front and back of the bundle 100, the invention is not so limited. In other embodiments the film may substantially enclose the bundle, such as illustrated in FIG. 2. As shown in FIG. 2, the film 150 covers the sides 137, 138 top 136 and bottom 139 of the stack, completely enclosing the stack, including the lateral sides of the stack.

The material used to overwrap and secure the consumer products may be any one of a number of well-known materials, such as paper or a plastic film. In certain instances, the overwrap material is a plastic film, and more preferably a thermoplastic film with the thermoplastic being either a monolayer or a laminate. Useful monolayer or laminate thermoplastic materials include polyethylenes and ethylene copolymers, polypropylenes and propylene copolymers, polyethylene terephthalates, vinyl polymers and copolymers, and acrylic polymers and copolymers. The laminates include thermoplastic/paper laminates. A useful thermoplastic is biaxially oriented polypropylene. The invention is not limited to a plastic as the packaging film. In other embodiments the packaging film may be a paper over-wrap or other material.

With continued reference to FIG. 1, the product bundle 100 may be provided with a brand name 200, indicia 202, and a sub-brand or descriptor 204. The indicia may communicate to the consumer one or more physical properties of the packaged goods. For example, in the illustrated embodiment the tissue 140 is a lotion treated tissue product and the indicia 202 is an illustrated drop of lotion. In other instances, the packaged good may be a tissue product comprising an anti-viral agent which conveys to the consumer a sense of therapeutic care. Indicia may then be chosen that will illustrate therapeutic care. For example, without being limited by any particular theory, it is thought that a cross is thought of by consumers as possessing qualities of therapeutic care.

The product bundles of the present invention may be arranged in a display, where the display comprises an array of products having physical properties that differ in at least one respect. In other embodiments the difference between properties may not be a matter of degrees, but rather whether a product possesses a certain property. For example, in one embodiment a first product may differ from a second product because the first product comprises a lotion and the second product does not. In other embodiments a first tissue product may be embossed and provide the product surface with topography and the second tissue product may be unembossed and have a substantially flat product surface, thus the first and second products may differ. In other instances, the array may comprise bundles comprising tissue products having a different number of plies, such as a first bundle comprising two ply products and a second bundle comprising three ply products. The bundles are provided with an overwrap having indicia indicative of the number of plies.

The display further comprises a plurality of packages for receiving and storing the displayed consumer products. In certain embodiments, the packages comprise packaging for consumer goods, such as tissue products and more preferably facial tissue products. The packages may be cartons or containers formed from blanks that may be folded flat and displayed on a shelf to be shopped by the consumer. In certain instances, the blank may comprise a flat folded cubic carton having a top panel, a bottom panel, a front panel, a pack panel and depending side flaps that may be folded to close the carton when erected by the consumer.

The blanks may be formed from a wide range of well-known container materials. Particularly preferred are paperboard material and flexible film materials. For example, the blanks may be formed from cardboard, carton stock, paper board, polypropylene, polyethylene, polystyrene, ABS plastic, plastic, metal, wood, and glass, amongst other suitable alternatives. In a preferred embodiment, the blank is made from coated paperboard and has a nominal thickness of about 0.5 mm.

Generally, one or more cartons are provided in a first, un-erected, carton configuration. In its un-erected configuration, the carton, which generally comprises a plurality of fold lines, may be in an unfolded or partially unfolded state. In its un-erected state, the carton may be substantially flat, and a plurality of substantially flat, un-erected cartons may be stacked together and displayed for purchase by the consumer. In this manner the un-erected cartons generally have a smaller volume than when in their erected form, which enables more cartons to be placed on display on a given shelf space for display and shopping by the consumer.

A consumer may erect the carton by folding along one or more of the carton fold lines to transform the carton into a second, erected, carton configuration where the erected carton has front and back walls that define a carton interior space for receiving a stack of tissues, particularly a stack of folded tissue sheets

When erected the cartons of the present invention may be filled by the consumer. More particularly, the consumer may fill the erected carton with a stack of tissues selected from an array of tissue products displayed at shelf along with the array of container blanks. In this manner the carton may be designed such that one or more of the carton walls may be opened and closed instead of being permanently closed with the use of adhesive, or the like. In one embodiment, one or more of the carton panels, such as a carton bottom panel, is opened and closed by use of a closing tab on one major bottom flap and a tab slot on the opposing major bottom flap. This allows for the container to be refilled with new sheet material when depleted. This also allows for a more expensive container having an expensive graphical treatment on the exterior to be sold since consumers may be willing to pay the increased costs of the container if it was also reusable or refillable. In other embodiments, one or more carton panels may be reopenable to facilitate refilling of the carton by using a fastener such as hook and loop material, pressure sensitive adhesives, magnets, pins, or the like.

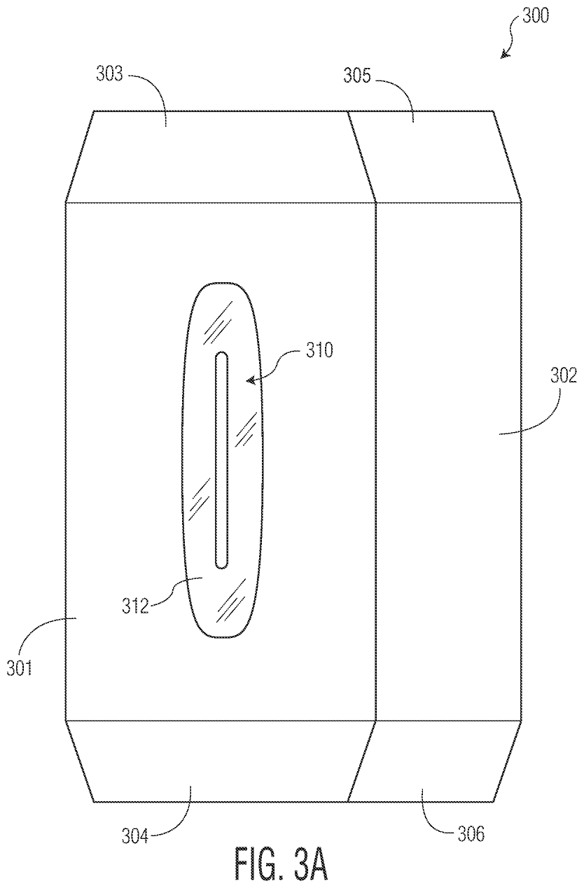

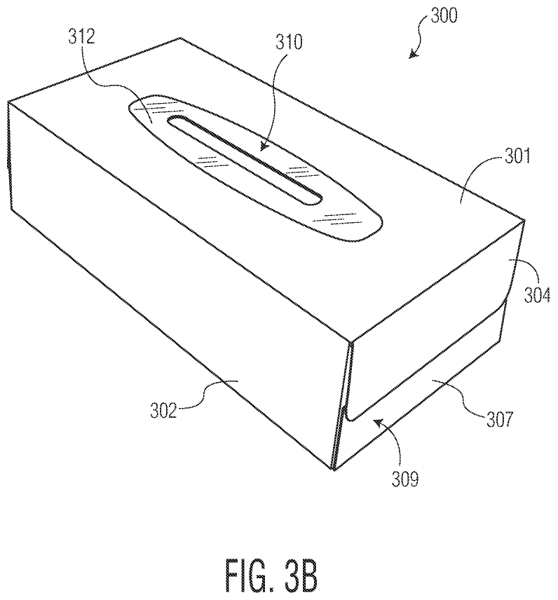

One non-limiting example of a first, un-erected, carton configuration is illustrated in FIG. 3A. The un-erected carton 300 comprises a top panel 301, a first side panel 302, first and second major end flaps 303, 304, and first and second minor end flaps 305, 306. The top panel 301, may comprise a dispensing opening 310 and optionally includes a dispensing window 312. The dispensing opening can be any size or shape such as square, circular, or oval. The dispensing opening can be located on any one of the panels.

In those embodiments where the carton blank comprises a dispensing widow, the window may be pre-attached to the carton blank by attaching the dispensing window to either the inside or the outside of the top panel, preferably on the inside. The dispensing window can be made from a suitable sheet material such as a film, nonwoven, or paper material that can retain a partially dispensed sheet, such as a facial tissue, within the dispensing opening for pop-up dispensing. The dispensing window has a dispensing opening that can be a slit that may be in form any number of geometric shapes such as an oval, a circle, a triangle, or X shaped. Alternatively, the dispensing window can be eliminated and fingers or tabs projecting into the dispensing opening can be used to retain a partially dispensed sheet.

In certain instances, the blank may further include an optional removable surfboard that can be attached to the top panel and at least partially cover the dispensing opening. The surfboard may be separated from the top panel by a perforation or a line of weakness.

The carton of FIG. 3A may be erected by the consumer to form the carton 300 of FIG. 3B, which comprises a first end 304 formed by a pair of folded major end flaps 307, 309. Preferably the major end flaps 307, 309 are not permanently sealed but rather may be reopened to provide access to the carton's interior volume and allow the carton to be refilled by the consumer.

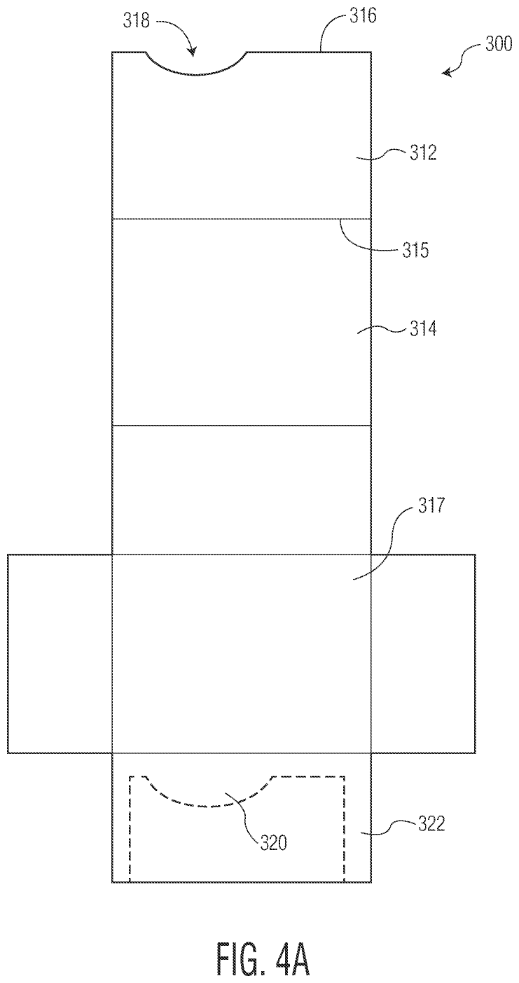

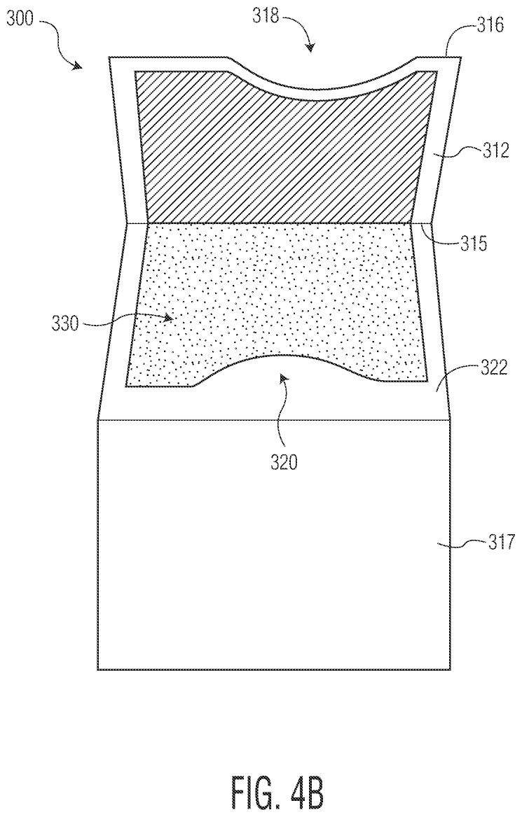

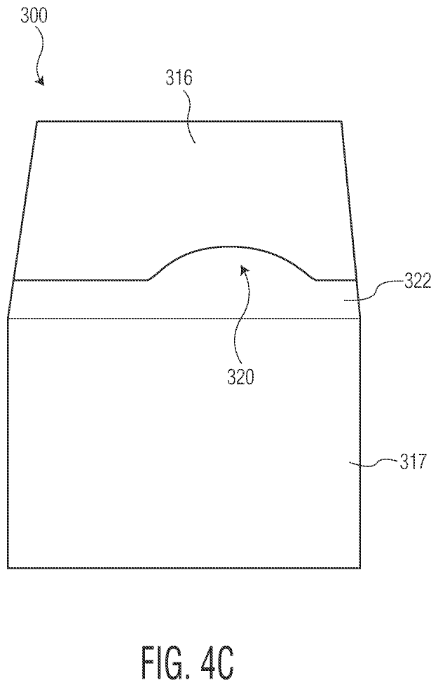

Another non-limiting example of a first, un-erected, carton configuration is illustrated in FIG. 4A. The un-erected, carton 300 has a substantially flat-shape. The un-erected, carton 300 is able to be converted into the re-closeable carton 300 of FIGS. 4B and 4C having a substantially parallelepiped-shape. The un-erected, carton 300 comprises a lid 312 foldably connected to the rear wall 314 at a fold line 315 which forms a hinge for opening and closing the lid of the re-closeable carton. The lid 312 has a transversal edge 316 having a cut out 318 shaped to receive a tab 320 disposed on the top wall 322. In use the tab 320 may be engaged with the cut out 318 such that the carton is reclosable.

With reference now to FIG. 4B the reclosable carton 300 constructed from the un-erected, carton of FIG. 4A is shown in an erected and open configuration. The consumer can open the reclosable carton 300 by grasping the lid 312 along the transversal edge 316 and opening, which remains hingedly connected to the rear wall 314. In its open configuration, a portion of the top wall 322 refines the carton opening 330. The consumer may refill the carton by opening the lid 312 and inserting a stack of tissue through the carton opening 320. The consumer may then close the lid 312 and insert the tab 320 into the cut-out 318 to close the carton 300, as illustrated in FIG. 4C.

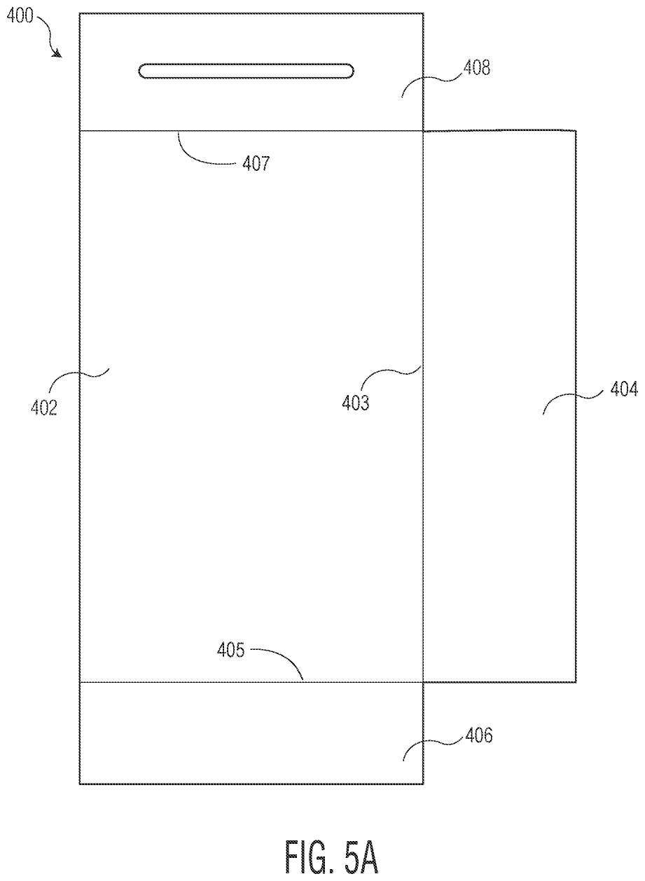

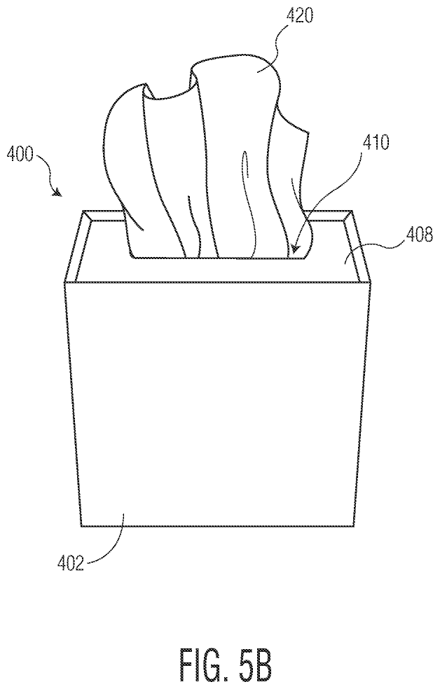

FIGS. 5A and 5B illustrate still another carton 400 useful in the present invention in a substantially flat, un-erected configuration (FIG. 5A) and in an erected configuration for use as a tissue dispenser (FIG. 5B). The substantially flat, un-erected carton of FIG. 5A comprises a front panel 402 and a side panel 404 separated from one another by longitudinal extending fold line 403. The carton further comprises a back panel (not illustrated in FIG. 5A) which is also separated from the first and second side panels by fold lines. The carton also comprises bottom and top walls 406, 408 attached to the front panel 402 along top and bottom 405, 407 transversal extending fold lines.

The carton of FIG. 5A may be erected by the consumer to form the carton 400 of FIG. 5B, which has a top panel 408 hingedly connected to the front panel 402. In this manner, the top panel may be opened and closed by the consumer to access the carton interior space and refill the carton with a stack of tissues. When the top panel 408 is closed the upper most tissue 420 in the stack may be partially dispensed through the dispensing opening 410 disposed on the top panel 408. In certain embodiments a dispensing window may cover the dispensing opening and the window may be provided with a slit or the like through which the tissues may be dispensed. The dispensing window can be made from a suitable sheet material such as a film, nonwoven, or paper material that can retain a partially a dispensed sheet, such as a facial tissue, within the dispensing opening for pop-up dispensing.

In yet another embodiment the cartons useful in the present invention may be bags or pouches formed from a flexible sheet material that may be folded in a first substantially flat configuration and then unfolded and filled with tissues by a consumer. While it may be desirable to form the dispenser from a flexible sheet material, such that it is bendable and compressible, it may also be preferred that the material have a degree of rigidity to resist deformation when a portion of the folded tissue products have been dispensed. Accordingly, suitable flexible material may have a bending resistance of between 21 and about 300 milligrams of force, such as from about 40 and 100 milligrams of force, such as from about 60 and about 90 milligrams of force. In certain instances, the bag or pouch may be formed from multiple panels having a thickness of at least about 1.5 mils, more particularly at least about 5 mils, and still more particularly between about 2 to about 3 mils, that are bonded together along their periphery.

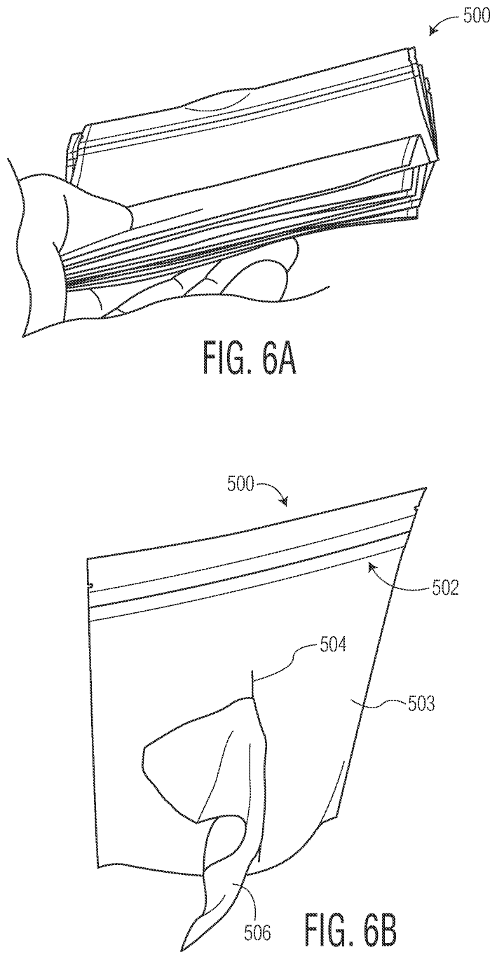

One embodiment of a flexible pouch 500 for storing and dispensing tissues is illustrated in FIGS. 6A and 6B. The pouch 500 is show in a folded, un-erected configuration in FIG. 6A and in an in-use configuration in FIG. 6B. As illustrated in FIG. 6A, the pouch 500 may be provided in a folded, substantially flat configuration for display at retail according to the present invention. Once purchased by a consumer, the pouch may be unfolded and filled with a stack of tissues. As shown in FIG. 6B, the pouch 500 may have a mechanism 502 for opening and resealing the pouch 500. The pouch is further provided with a dispensing opening 504 disposed on the front face 503 of the pouch 500, through which tissues 506 may be dispensed.

The bundles of tissue products and packages may be arranged in an array of products that reside on the same shelf in a retail store and/or in the same aisle in a retail store to be shopped by a consumer. In this manner at least one bundle of tissue products may be displayed on a shelf at a point of sale, such as within a retail store, along with a plurality of cartons for storing and dispensing the bundle of tissue products. The products and cartons may be displayed in such a way that the they are all visible to a consumer during the consumer's purchasing decision process and the consumer may select the desired bundle of tissue product and carton separately and then combine them later, preferably away from the store, to form a carton for dispensing a stack of tissues.

Generally, the array comprises at least two tissue products where the tissue products differ in at least one regard. The difference may be, for example, in the number of sheets in a bundle, the bundle configuration, the ply count, an intrinsic property, embossing pattern, price point, brand name, sub-brand name, container graphic indica, or the like.

In one embodiment the array of tissue products of the present invention may comprise tissue products having a differing number of plies. For example, the array may comprise a two-ply tissue product and a three-ply tissue product.

In another embodiment the array of tissue products may comprise two or more tissue products each of which comprises at least one value of a common intensive property that is different from at least one or more of the others. For example, the array may comprise a first tissue product having a first geometric mean tensile strength and a second tissue product having a second geometric mean tensile strength that is less than the first.

In other embodiments the array of tissue products may comprise a first tissue product comprising an additive and a second tissue product that is substantially free from the additive. Additives may include, for example, softening agents, temporary wet strength agents, permanent wet strength agents, bulk softening agents, lotions, silicones, and other types of additives suitable for inclusion in and/or on tissue products. In one example, the first tissue product comprises a lotion applied to its surface and the second tissue product is substantially free from lotion.

In still another embodiment, two more tissue products within an array of tissue products may differ in price, for example differ in retail price to a consumer.

The display further comprises two or more containers for storing and dispensing a tissue product. Suitable containers may include packages, cartons, pouches, bags, and the like, particularly the cartons illustrated in FIGS. 3-6. Generally, the two or more containers differ from one another in at least one regard. For example, the containers may differ in regard to material, shape, dispensing configuration, volume, surface area, tissue capacity, number of panels, carton graphics, and the like. In certain preferred embodiments the containers are refillable. In other embodiments the containers are provided in a first configuration, which is preferably a substantially flat configuration, that are reconfigured by a consumer to a second configuration. Generally, the first configuration will be the configuration in which the containers are displayed within the array the second configuration will be the in-use configuration. In other instances, the array may comprise both un-erected and erected containers.

In certain instances, the store display may also include indicia, such as a non-textual graphic, relating to properties of the tissue products and/or the containers. The indicia may be formed on, printed on, and/or positioned on the display adjacent to the relevant product or container to aid the consumer in selecting the correct product or container.

Generally, the foregoing display allows the consumer flexibility to choose tissue products and containers separately and to mix and match as desired. The display also provides the consumer with the option of purchasing refill tissue products to be used in containers previously purchased. While this flexibility is generally appreciated by the consumer, in certain instances, it may be useful to also provide the display with prepackaged tissue products. For example, the display may comprise one or more packages of tissue products having tissue products disposed in a container and ready for purchase and use by the consumer. Any one of the well-known and currently available prepackaged tissue products may be incorporated into the inventive display in this manner.

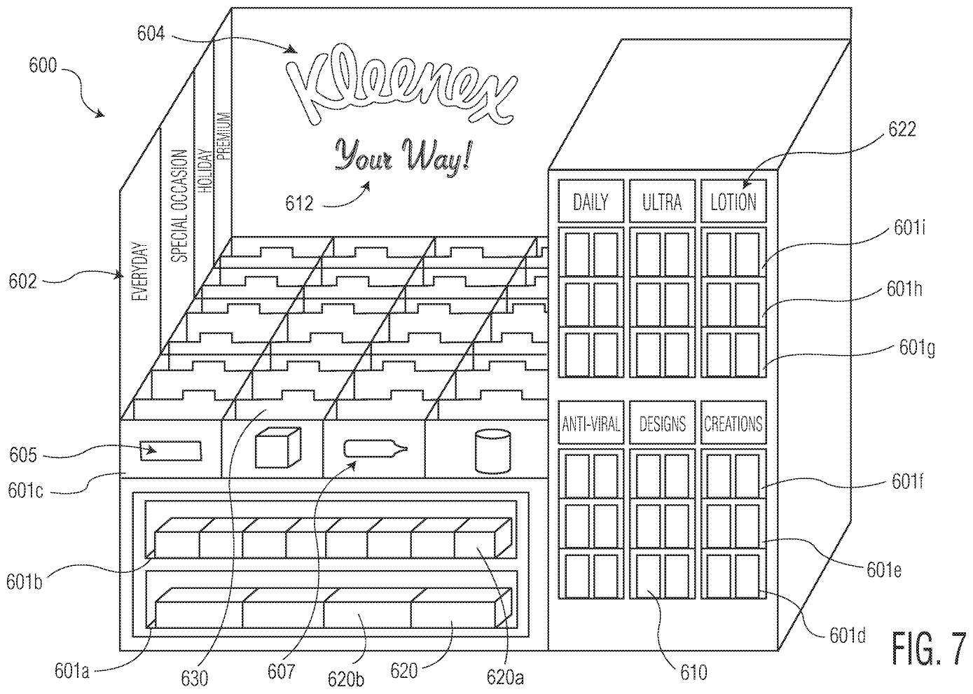

With reference now to FIG. 7, one embodiment of a display 600 of tissue products and packaging according to the present invention is illustrated. The display of products of the present invention may be displayed by any suitable process and any suitable location, such as a retail store, for a consumer's viewing, identification, selection, or purchasing. In the illustrated embodiment, the display 600 comprises a plurality of shelves 601a-601i, such as conventional shelving commonly found in retail stores, each of the shelves 601a-601i having bundled packages of tissue products 610, a filled tissue products 620 (a tissue product housed in a package indented for storing and dispending the tissue product), and unfilled packages 630 disposed thereon. Preferably the bundles of tissue products 610, filled tissue products 620, and unfilled packages 630 are displayed on the shelves 601 separate from each other as individual units in a way that each is visible to a consumer during the consumer's purchasing decision process and may be selected and sold individually. In this manner the consumer may be choose a tissue product and its packaging separately and then later erect the tissue package and fill it with the selected tissue product. This provides the consumer with increased choice and flexibility in selecting both products and their associated packaging.

The display 600 may further comprise one or more indicia 602 that communicate to the consumer one or more attributes of the array of substantially flat, un-erected and unfilled packages 630. For example, in the illustrated embodiment, textual indicia “EVERYDAY,” “SPECIAL OCCASION,” “HOLIDAY,” and “PREMIUM” communicate to the consumer the graphics printed on the respective unfilled packages 630. Thus, the illustrated array of packages 630 comprises four different packages and at least four different graphics disposed on those packages, although within a given category the graphics may differ to a degree. In the present example, the indicia 602 comprise words, however, it is to be understood that the indicia may be non-textual, such as symbols, shapes, images, colors, patterns, or combinations thereof, or other suitable indicators capable of communicating to a consumer.

In certain embodiments it may be preferable that all of the products and packages 610, 620, 630 in the display 600 each comprise a common brand name and that the brand name 604 be incorporated into the display 600. For example, in the illustrated embodiment, the display 600 includes the Kleenex® brand name and each of the products and packages 610, 620, 630 may further be marketed or packaged under the Kleenex® brand name. While it may be preferable that all of the products and packages 610, 620, 630 within the display 600 have a common brand name 604 the products and packages 610, 620, 630 may include other textual or non-textual indicia that are matched to one or more properties of the products or packages and differ amongst the products or packages. For example, as illustrated in FIG. 7, the array may comprise four different unfilled packages 630. The packages 630, which are each unfilled, differ from one another in at least one aspect in respect to the shape of the erected package. This difference may be communicated by non-textual indicia 605 on a face of the display 607.

With continued reference to FIG. 7, the display 600 may further comprise one or more filled tissue products 620 (a tissue product housed in a package). The filled tissue products 620 may include packages that differ in at least one regard, such as different shaped packages 620a and 620b. In other instances, the filled tissue products may also differ in regard to the type of tissue products contained therein. For example, a first filled tissue product may contain a tissue product having a first intensive property and the second filled tissue product containing a tissue product having a second intensive property that is different than the first intensive property. The differences in the filled tissue products, whether they be in the package or the tissue products contained therein, may be communicated to the consumer by either textual or non-textual indicia disposed on the package or incorporated into the array. For example, in one embodiment, the first filled tissue product contains a lotion tissue treated product, which is communicated by a first non-textual indicia and the second filled tissue product contains tissue product treated with anti-viral agent, which is communicated by a second non-textual indicia.

The display 600 also comprises one or more unfilled packages 630. The unfilled packages are preferably provided in an un-erected, substantially flat, configuration. In the illustrated embodiment, the array comprises four packages 630 that differ from one another in respect to the shape of the erected package. This difference in unfilled packages 630 is communicated by non-textual indicia 605 on the face 607 of the display 600. In other instances, the packages may differ in regard to material, shape, dispensing configuration, volume, surface area, tissue capacity, number of panels, or the like. Generally, the unfilled packages are arranged in the array in a way that each is visible to a consumer during the consumer's purchasing decision process and that are designed to be sold individually.

The one or more unfilled packages 630 are generally displayed in the display 600 along with one or more the product bundles 610. Preferably the product bundles are bundles of tissue products that may be combined with the unfilled packages to form a filled tissue package. In this manner, a consumer may shop the array by selecting their desired unfilled package and desired bundle of tissue products and then combine them later to form a filled tissue package. This provides the consumer with a high degree of customization and greatly increases the number of packaging and product combinations that may be offered to the consumer in a given retail space. For example, the same amount of shelf space commonly used to house a single type of package and product may be used to house packages and bundles that may be combined to form 3, 4, 5, 6, 7, 8, or more different filled tissue packages. Thus, arrays of the present invention may offer consumers with increased selection and customization while making efficient use of shelf space.

With continued reference to FIG. 7, the display 600 may be provided with a brand name 604, and sub-brand or descriptor 612. The sub-brand or descriptor may further communicate to the consumer one or more attributes of the display. The display 600 may further include other indicia to communicate to the consumer one or more physical properties of the displayed products and packages 610, 620, 630. For example, if the bundle of tissue products comprises a lotion treated tissue product the display may include an illustrated drop of lotion. In other instances, the bundle of tissue products may comprise a tissue product having an anti-viral agent and the display may include indicia that communicates therapeutic care, such as a cross. In other instances, the indicia may simply be textual indica that describe one or more attributes of the bundled products.

We claim:

1. A display of consumer products comprising:
a. an array of two or more packaged consumer goods, the two or more packaged consumer goods having at least one physical property that is different; and
b. an array of two or more packages for receiving and storing the packaged consumer goods, the two or more packages having at least one physical property that is different and wherein the packages are unfilled.

2. The display of claim 1 wherein the packaged consumer goods comprise wet or dry tissue products.

3. The display of claim 1 wherein the packaged consumer goods comprise a tissue product disposed in a packaging.

4. The display of claim 3 wherein the packaging does not consist of a dispensing opening.

5. The display of claim 3 wherein the tissue product comprises a dry tissue product and the packaging comprises a wrapper.

6. The display of claim 5 wherein the tissue product comprise a stack of folded tissue sheets and the wrapper entirely overwraps the stack.

7. The display of claim 6 wherein the stack is substantially cubic, and the wrapper consists of either plastic or paper sheet material.

8. The display of claim 1 wherein the consumer goods are wet or dry tissue products and the at least one physical property that differs amongst the wet or dry tissue products is selected from surface treatment, surface topography, number of plies, absorbency, caliper, basis weight, bulk, softness, slough and tensile property.

9. The display of claim 1 wherein the at least one physical property that differs amongst the two or more consumer goods is non-textual indicia selected from visual indicia, textural indica, audio indicia, and scent indicia.

10. The display of claim 1 wherein the at least one physical property that differs amongst the two or more packages is selected from material, number of panels, panel configuration, erected size, erected shape, erected volume, dispensing configuration, color, texture, and package graphics.

11. The display of claim 1 wherein the two or more packages are un-erected.

12. The display of claim 11 wherein the un-erected packages are provided in a substantially flat configuration.

13. The display of claim 1 wherein the two or more packages are cartons for storing and dispensing stacks of folded tissue sheets, the packages comprising a plurality of panels and a dispensing opening disposed on at least one of the plurality of panels.

14. The display of claim 1 wherein the packaged consumer goods and the packages comprise a common brand name.

15. A display of tissue product and packaging for storing and dispensing the tissue product comprising:
a. an array of two or more tissue products, the two or more tissue products having at least one physical property that is different; and
b. an array of two or more packages configured to receive, store, and dispense a tissue product, the two or more packages having at least one physical property that is different and wherein the packages are unfilled.

16. The display of claim 15 wherein the tissue products comprise wet or dry tissue products.

17. The display of claim 15 wherein the tissue products comprise dry tissue products and the dry tissue products are packaged.

18. The display of claim 17 wherein the packaged dry tissue products comprise a stack of folded tissue sheets and a wrapper at least partially overwrapping the stack.

19. The display of claim 18 wherein the stack is substantially cubic, and the wrapper consists of either plastic or paper sheet material.

20. The display of claim 15 wherein the at least one physical property that differs amongst the two or more tissue products is selected from surface treatment, surface topography, number of plies, absorbency, caliper, basis weight, bulk, softness, slough, and tensile property.

21. The display of claim 15 wherein the at least one physical property that differs amongst the two or more tissue products is non-textual indicia selected from visual indicia, textural indica, audio indicia and scent indicia.

22. The display of claim 15 wherein the least one physical property that differs amongst the two or more packages is selected from material, number of panels, panel configuration, erected size, erected shape, erected volume, dispensing configuration, color, texture, and package graphics.

23. The display of claim 15 wherein the two or more packages are un-erected.

24. The display of claim 23 wherein the un-erected packages are provided in a substantially flat configuration.

25. The display of claim 15 wherein the tissue products and the packages configured to receive, store, and dispense the tissue products comprise a common brand name.

26. A display of tissue product and packaging for storing and dispensing the tissue product comprising:
a. an array of two or more tissue products, the two or more tissue products having at least one physical property that is different;
b. an array of two or more packages configured to receive, store, and dispense a tissue product, the two or more packages having at least one physical property that is different and wherein the packages are unfilled and displayed in an un-erected state;
c. an array of two or more packages configured to receive, store, and dispense a tissue product, the two or more packages having at least one physical property that is different and wherein the packages are unfilled and displayed in an erected state; and
d. an array of two or more packaged tissue products comprising a package comprising a plurality of panels and a dispensing opening disposed on at least one of the panels and a plurality of tissue products disposed within the package.

27. The display of claim 26 wherein the tissue products comprise a substantially cubic stack of folded tissue sheets and a plastic or paper wrapper at least partially overwrapping the stack.

28. The display of claim 26 wherein the at least one physical property that differs amongst the two or more tissue products is selected from surface treatment, surface topography, number of plies, absorbency, caliper, basis weight, bulk, softness, slough, and tensile property.

29. The display of claim 26 wherein the least one physical property that differs amongst the two or more packages is selected from material, number of panels, panel configuration, erected size, erected shape, erected volume, dispensing configuration, color, texture, and package graphics.

30. The display of claim 26 wherein the two or more tissue products, the two or more un-erected packages, the two or more erected packages and the two or more packaged tissue products all comprise a common brand name.
